(19) United States
(12) Patent Application Publication
(10) Pub. No.: US 2018/0185744 A1
(43) Pub. Date: Jul. 5, 2018

(54) Computer Vision and Capabilities For Tabletop Gaming

(71) Applicants: Karthik Veeramani, Hillsboro, OR (US); William J. Lewis, North Plains, OR (US); Nelson Kidd, Camas, WA (US); Paul R. Zurcher, Beaverton, OR (US); Ajit P. Joshi, Portland, OR (US)

(72) Inventors: Karthik Veeramani, Hillsboro, OR (US); William J. Lewis, North Plains, OR (US); Nelson Kidd, Camas, WA (US); Paul R. Zurcher, Beaverton, OR (US); Ajit P. Joshi, Portland, OR (US)

(21) Appl. No.: 15/395,841

(22) Filed: Dec. 30, 2016

(51) Int. Cl. A63F 3/00; G09B 19/22; A63F 3/02; A63F 13/213; A63F 13/245; A63F 13/25; A63F 13/822; G09B 5/06; G06T 7/11

(52) U.S. Cl. CPC A63F 3/00895; G09B 19/22; A63F 3/02; A63F 13/213; A63F 13/245; A63F 13/25; G06T 2207/20084; G09B 5/06; G06T 7/11; A63F 2300/1093; A63F 2300/807; G06T 2207/10004; A63F 13/822

(57) ABSTRACT

Systems, apparatuses and methods to apply computer capabilities to tabletop games including board games such as the game of chess. In one embodiment, a camera connected to smart glasses repeatedly feeds real-time images of a board game to a computer vision system that identifies the game, breaks the game board into elementary segments (e.g., individual squares), and identifies game pieces located on the segments. A game state may be determined by reference to a listing of pieces on each segment and a rule set. In addition, hints and/or other guidance may be provided to the player. Moreover, the game state may be described in a standard notation and/or may be transmitted to remote locations for use by other players.

### TECHNICAL FIELD

Embodiments generally relate to computer vision in gaming. More particularly, embodiments relate to providing computer vision and computer capabilities to a game having standard elements that is played in a physical space.

### BACKGROUND

People enjoy playing games, such as board games, for the related social aspects, for the competition, and so on. In recent years, electronic versions of games have been developed that provide for competition against a computer or provide for remote play against a human opponent via a communications link. The interface may, however, be cumbersome in many cases. For example, a player that is playing a chess game remotely may be forced to use an electronic keyboard to enter desired moves and then follow the game on a screen. Even where a physical keyboard is used, providing the keyboard with the capabilities of machine intelligence may require the use of specially instrumented game boards and game pieces so that movement of pieces triggers electronic signals that can be interpreted to an underlying machine intelligence. Such an approach may relatively increase expense, especially if specialized hardware must be bought for every game of interest.

In addition to playing against a remote player, a player may want to play a physical game locally, but may wish to avail himself of some of the benefits of computer play such as obtaining hints or guidance. This may be especially useful to a novice of the game, who may not know the rules of the game well.

### BRIEF DESCRIPTION OF THE DRAWINGS

The various advantages of the embodiments will become apparent to one skilled in the art by reading the following specification and appended claims, and by referencing the following drawings, in which:

FIG. 1A is an illustration of an example of a game system employed in game play between two players according to an embodiment;

FIG. 1B is a close-up view of a game board and game pieces in the context of game play according to an embodiment;

FIG. 2 is a block diagram of an example of a system to provide computer vision and capabilities according an embodiment;

FIG. 3 is a block diagram of an example of a plugin according to an embodiment;

FIG. 4 is flowchart of an example of a method of identifying a game from an image of a game according to an embodiment;

FIG. 5 is a flowchart of an example of a method of segmenting a game board and identifying a game state according to an embodiment;

FIG. 6 is a flowchart of an example of a method of identifying game pieces according to an embodiment;

FIG. 7 is a block diagram of an example of a processor according to an embodiment; and

FIG. 8 is a block diagram of an example of a computing system according to an embodiment.

### DESCRIPTION OF EMBODIMENTS

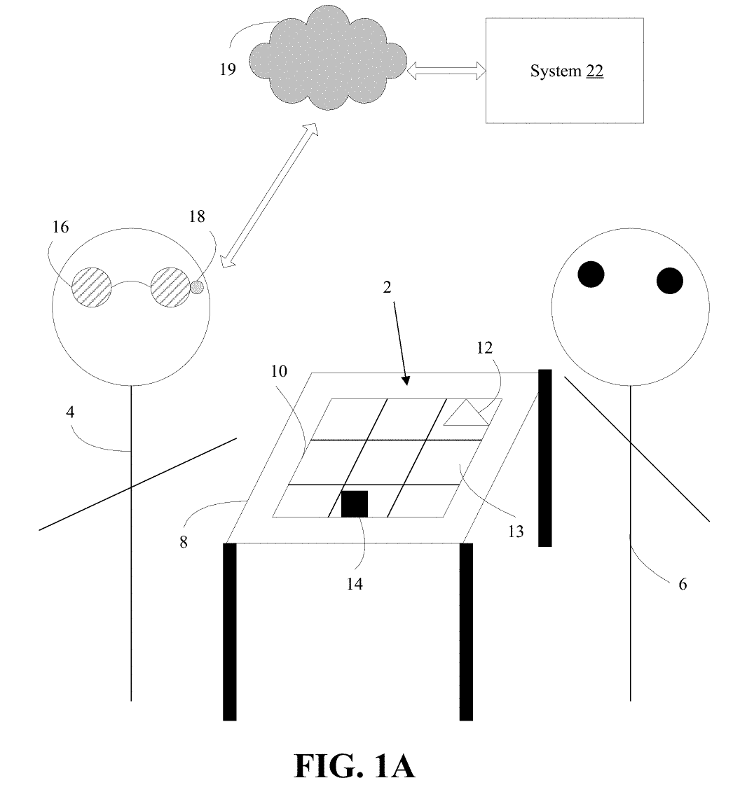

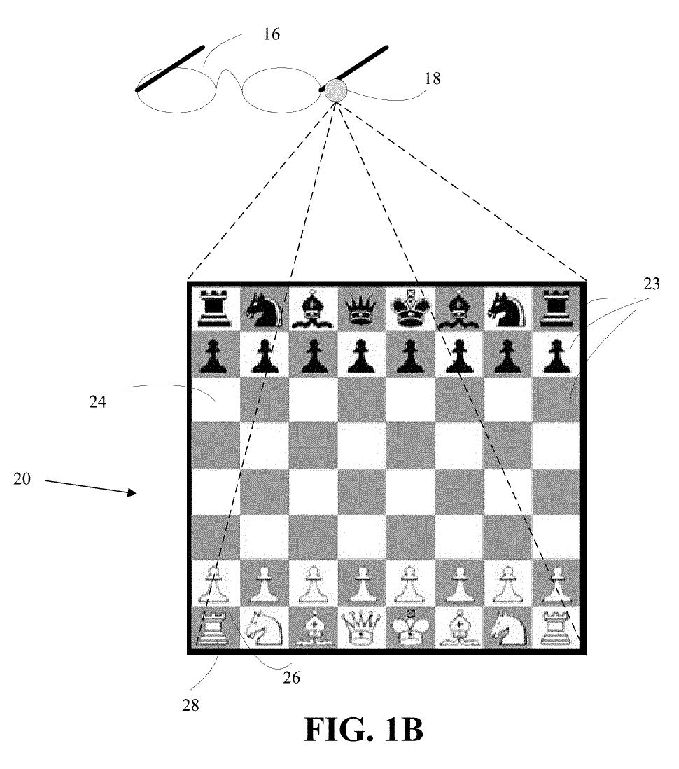

FIG. 1A shows a board game 2 played by a first player 4 and a second player 6. The board game 2 may be played on top of a table, such as table 8, and therefore may be referred to as a tabletop game even when it is not played on a table. In this regard, tabletop games may, for example, be played on the ground, a chair, a bed, a counter top, or any physical surface that supports the game. In addition, board games may include several game elements. For example, the illustrated board game 2 includes a board 10 divided into segments 13 (e.g., squares or other shapes) that accommodate various game pieces. In FIG. 1A, the two game pieces are a triangle 12 and a square 14. Thus, the board game with which embodiments may be employed may be chess, Go, checkers, or any other board game.

Of note is that board games are often played in person using a board, such as the board 10, and physical pieces that a player can grasp, such as the game pieces 12, 14. This is the original manner in which such games were played, as their development may have vastly predated electronic technology. Players continue to play games in this original manner. Advantageously, however, a player may benefit from one or more aspects of embodiments when playing a traditional tabletop game. Indeed, aspects of embodiments may enrich user experience by providing communication with remote players, game guidance, and access to rules without having to look them up in a book. Applicant's embodiments also provide an overlay of machine intelligence to traditional tabletop and other games, and/or may include computer vision for a game being played in physical space.

In the illustrated example, player 4 wears smart glasses 16 that include a camera 18, such as a depth camera. In other embodiments, virtual reality goggles equipped with cameras may be used instead of or in conjunction with smart glasses, and in yet other embodiments, both players may wear smart glasses. Also, in some embodiments, instead of being integrated into a pair of smart glasses, the camera may be located elsewhere. The camera may be integrated into a hat or a headband worn by a player, or not worn by the player at all. For example, the camera may be located on a ceiling above the game, on a wall, on a tripod, on a camera mount, etc., so long as the game 2 is visible to the camera (e.g., in a field of view of the camera). In the illustrated example, the camera 18 transmits images of the game via cloud 19 to a system 22 that provides computer vision and computer capabilities as an overlay of an experience of playing a game in physical space. In other embodiments, the system 22 may be local to the camera 18 (e.g., physically reside at a camera), local to the player 4 (e.g., physically reside at a location of a user), local to the board game 2, and so on.

FIG. 1B illustrates game play in the context of a chessboard 20. The basic element of a chessboard is a square, here shown as a plurality of segments 23. There are sixty-four (64) segments 23 in a chessboard, and they alternatingly differ in color. A similar board may be used for the game checkers, and a different board will be used for the game Go. The game pieces of the chessboard are the familiar game pieces 28 of chess: pawns, rooks, knights, etc. Each type of game piece has a distinctive shape and/or color. Some of the squares are empty, such as square 24, whereas others squares are occupied, such as square 26 that is occupied by one of game pieces 28. Notably, a game state of a game is where the play is presently at (e.g., a location of specific game pieces on squares). As illustrated at FIG. 1B, the game state of the chessboard 20 is the starting state of every game of chess. As the game progresses and the game pieces move about, or are removed from the board or changed, the game state changes. The game state may be recorded in a number of known, standard notations, including Portable Game Notation format (PGN), that specify the location of each game piece on the board. FIG. 1B also shows the use of smart glasses 16 that include the camera 18. The camera 18 may have a view of the entire board, and all of the game pieces on it.

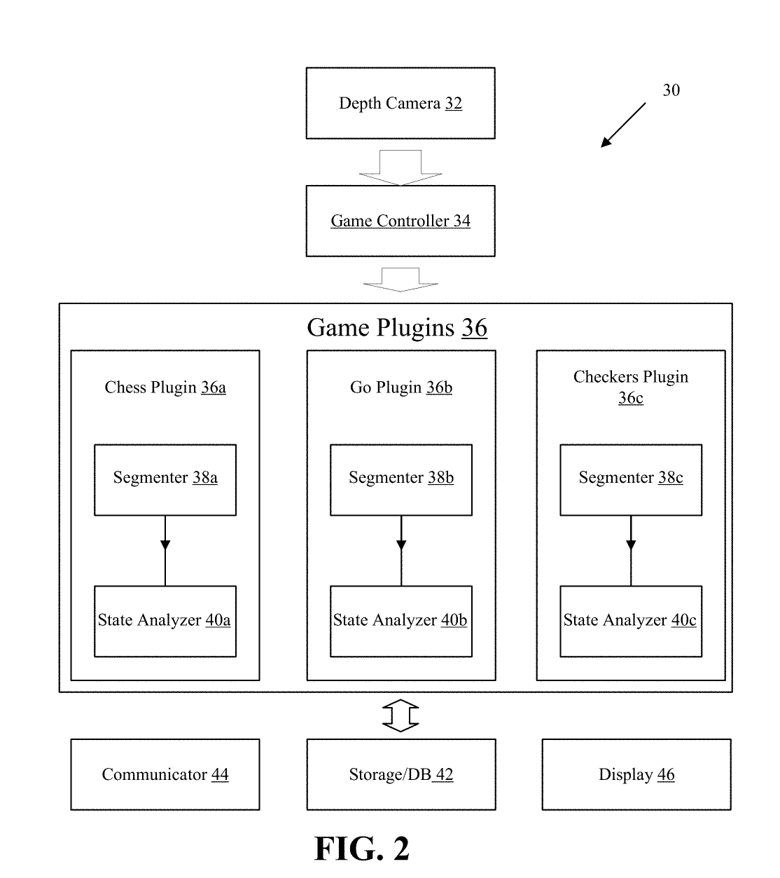

Turning to FIG. 2, a block diagram of a system 30 to provide a physical, tabletop game with both computer vision and computer-augmented capabilities is shown according to an embodiment. In one example, the system 30 may include logic (e.g., logic instructions, configurable logic, fixed-functionality logic hardware, etc.) configured to implement any of the herein mentioned technologies including, for example, segmenting an image, analyzing a state of a game, and so on. In the illustrated example, a camera 32 takes a series of images of a game as it is underway (e.g., being played). The camera 32 may be a part of virtual reality system, may be a part of smart glasses such as smart glasses 16 (FIGS. 1A-2B), already discussed, may be located elsewhere in the vicinity of the game, and so on. The camera 32 may be a depth camera.

In the illustrated example, the digital image data generated by the camera 32 is passed to a game controller 34, which may pre-process the image data to facilitate subsequent analysis of the data by, for example, a convolutional neural network (CNN). The pre-processing may include operations on light and depth values to recast the data into a format the CNN may have been trained to process, and may further include color space conversion processes to adjust the optical-to-electrical transfer function of the image for a higher dynamic rate. In some embodiments, the pre-processing may be handled by the camera 32 itself, but in the illustrated embodiment, the pre-processing is at the game controller 34 to facilitate tailoring and/or optimizing the pre-processing without changing camera sensors themselves.

In the illustrated example, the image data, which as noted above may be transformed for use by a CNN, is passed to a plurality of game plugins 36 (36a-36c), which are specific to particular games. For example, in the illustrated example, three game plugins are shown: a chess plugin 36a, a Go plugin 36b, and a checkers plugin 36c. Each plugin may use a CNN to determine the identity of the game within a minimally acceptable confidence level. If game identification is not made with sufficient confidence, then the game controller 34 may load other game plugins until a suitable identification is made. While the illustrated example includes the three game plugins 36a-36c, greater or fewer game plugins may be provided, depending for example on a number of games to be considered. Plugins may themselves be provided with a system, or made available for purchase on a per-plugin, per game, and/or per multi-game basis. In addition, and while the identity of the game is determined by the game plugins 36, the game controller 34 itself may apply the CNN to the processed image data to determine the identity of the game.

In the illustrated example, each of the game plugins 36 includes a respective segmenter: a segmenter 38a for the chess plugin 36a, a segmenter 38b for the Go plugin 36b, and a segmenter 38c for the checkers plugin 36c. Similarly, each of the game plugins 36 includes a respective state analyzer: a state analyzer 40a for the chess plugin 36a, a state analyzer 40b for the Go plugin 36b, and a state analyzer 40c for the checkers plugin 36c. The operation of a segmenter and a state analyzer will now be discussed with reference to the chess plugin 36a, although similar operation may apply for a segmenter and a state analyzer associated with another plugin. The segmenter 38a of the chess plugin 36a divides the image of a chessboard into a series of segments that correspond to a basic unit of the chessboard (e.g., individual squares). The segmenter 38a further identifies game pieces, if any, that may be located at the basic unit (e.g., a particular square). In one example, the identification is passed to the state analyzer 40a, which determines a game state for the game.

The state analyzer 40a may record a game state of a game using any convenient notation, such as PGN, for transmission to remote players equipped with the system or with other means for reading PGN notation. In the game of chess, the game state is the chessboard as it exists at a moment in time (e.g., the chess pieces and their location on the chessboard) and may be recorded by the state analyzer 40a. The state analyzer 40a may also determine if a proffered move is valid. In this regard, novices to a game often attempt moves that are not valid. The state analyzer 40a may update the game state if the move appears to be valid, writing the moves and game state to storage 42 and/or sending the game state via a communicator 44 (e.g., via a communication channel) over a network to remote players.

The system 30 may also provide a player with playing hints or other game play guidance. Hints and guidance may be provided audibly or visually to a player wearing an apparatus having a display 46, such a display located on smart glasses 16 (FIGS. 1A-B), discussed above, a display that is part of a pair of virtual reality goggles, and so on.

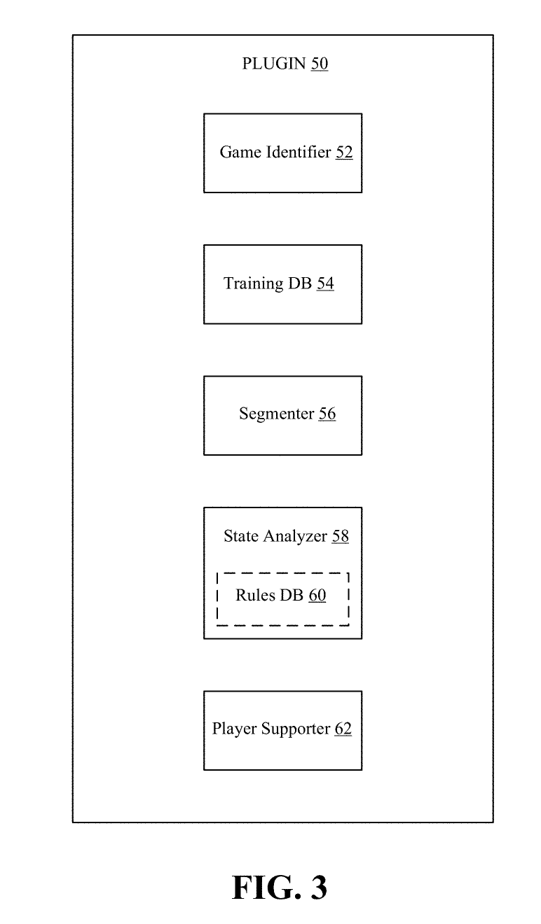

FIG. 3 shows a plugin 50, which may be used with the system 30 (FIG. 2), discussed above. In one example, the plugin 50 may include logic (e.g., logic instructions, configurable logic, fixed-functionality logic hardware, etc.) configured to implement any of the herein mentioned technologies including, for example, identifying a game, training, segmenting an image, analyzing a state of a game, and so on. In the illustrated example, a game identifier 52 identifies a game. The game identifier 52 may use a training database 54 to train a CNN to identify the game. Other approaches, however, may be used to make the determination including other image matching techniques using image analysis. For example, if the game includes a game board that is similar in appearance to a chessboard, and if the game pieces on the game board are similar in appearance to the appearance of chess game pieces in a library to which the plugin has access, the game identifier 52 may determine that the game is chess based on image analysis.

In the illustrated example, the plugin 50 includes a segmenter 56 that segments the board into elementally relevant parts which, in the case of chess, will correspond to the individual squares of the chessboard. The segmenter 56 may use a CNN and the training database 54 to match any game piece presently on a segment to known game pieces associated with chess, such as pawns, rooks, bishops etc. Thus, CNN and/or other approaches, including other forms of image matching using image analysis, may be used by the segmenter 56. For example, if the game piece is sufficiently similar in appearance to a pawn, then the segmenter 56 may identify the game piece at a given segment (e.g., on a particular square) as a pawn.

In the illustrated example, the plugin 50 includes a state analyzer 58 to determine the game state. The state analyzer 58 may have access to a rules database 60, which provides the state analyzer 58 with a rule set for the game including rules for determining whether a given move is valid (e.g., legal or not). The rules database may be provided as part of the state analyzer 58 as shown in FIG. 3, or it may be located elsewhere in the plugin 50 or, in other embodiments, be located remotely from the plugin 50. The state analyzer 58 may also express the game state in a notation that can be conveyed over a network to other electronic systems and to remote players.

In some situations, as when the camera 32 lacks a proper view of the game, either the game controller 34, game identifier 52, segmenter 56, or state analyzer 58 may determine that a different point of view of the game is required and signal a player to move the game or the camera so that a more suitable image can be taken.

The illustrated plugin 50 further includes a player supporter 62 that operates on the game state to determine suggestions of moves to be made by the player. The suggestions may be conveyed to the player. In addition, the player supporter 62 may warn the player of a mistake in his/her play, apprise the player of a rule the player may not understand, provide other information (e.g., scoring, information on the player's opponent, advertising, etc.) to the player, either through audio or via video or both, and so on.

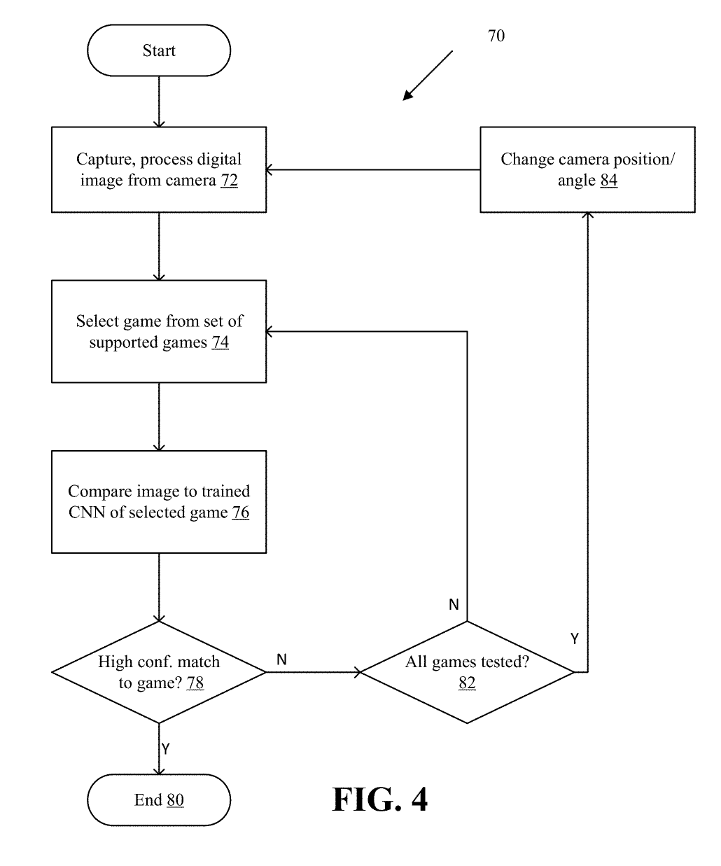

Turning now to FIG. 4, a flowchart of a method 70 of identifying a game from an image of a game is shown according to an embodiment. The method 70 may generally be implemented in one or more modules as a set of logic instructions stored in a machine- or computer-readable storage medium such as random access memory (RAM), read only memory (ROM), programmable ROM (PROM), firmware (FW), flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof.

For example, computer program code to carry out operations shown in method 70 may be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 72 captures a digital image taken by a camera of a game being played in a field of view of the camera. Images may be captured at a regular periodic interval suitable for the game in question, or at discrete times chosen by one or both players (e.g., whenever a move is made by a player). The image may be processed to transform the data to a type compatible with a type of image analysis to be employed. For example, the image data may be altered to conform a training process that may have been employed with a CNN, including adjusting an optical-to-electrical transfer function for a higher dynamic range.

Illustrated processing block 74 may direct a game controller such as the game controller 34 (FIG. 2), discussed above, to query a game plugin such as the game plugins 36 (FIG. 2), discussed above, to determine if the image is of a known game that the plugin can handle. The plugin may determine the identity of the game at processing block 76 by comparing the image taken at block 72 to a CNN trained to identify images of the game associated with the particular plugin. Illustrated processing block 78 determines whether there is a match to a game at a suitably high confidence level. If so, the game is identified and the identification is completed at block 80. If not, there is no match at a suitably high level of confidence, and block 82 determines whether all games have been tested. If not, control passes back to processing block 74, where a different game is selected, such as by selecting a different game plugin. If there is no suitable match and all of the available games have been tested, there may be an issue at the camera (e.g., camera positon, angle, etc.).

For example, the camera may not have a clear enough view of the game and the player may be prompted to shift the camera position and/or angle at processing block 84. In this regard, another digital image is taken at block 72 and the process continues as described above. In one example where a match of the game cannot be accomplished, the player may be informed that there is no match with the available game plugins and may be prompted to download an appropriate plugin, provide user input to be used to identify the game, and so on.

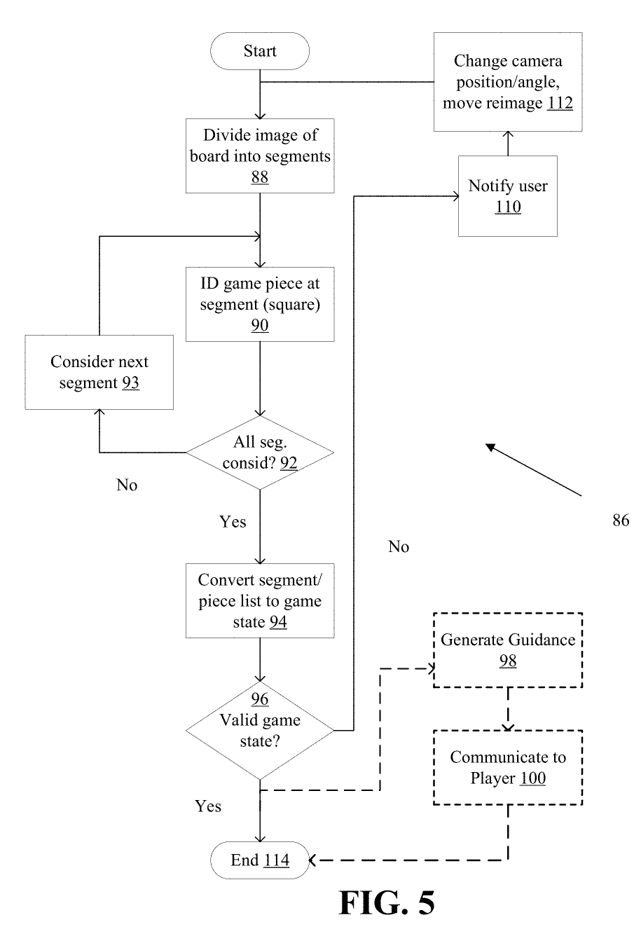

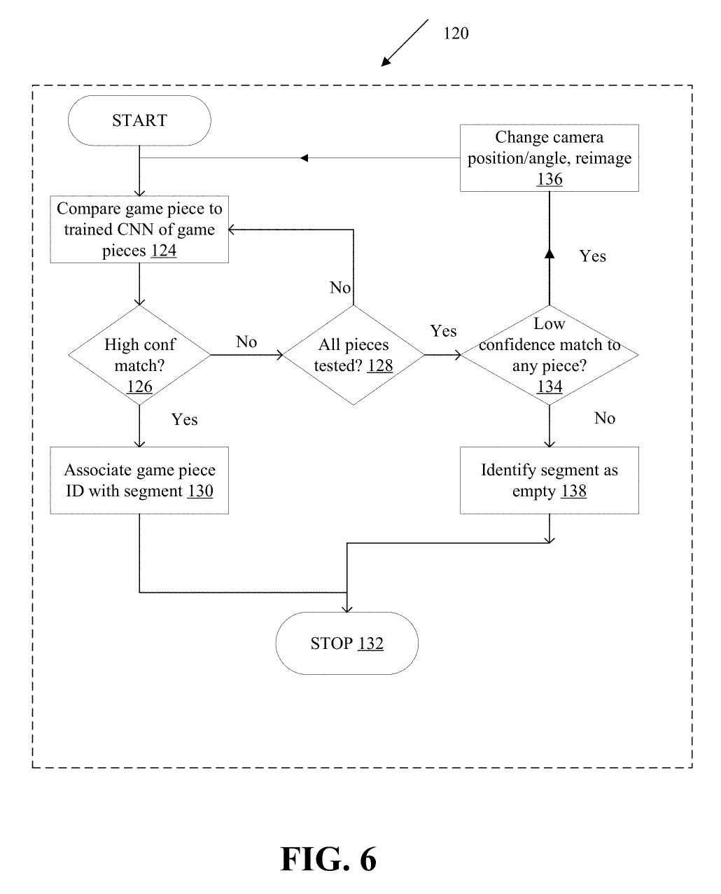

FIG. 5 and FIG. 6 show flowcharts of a method 86 and a method 120 of segmenting a game board and identifying a game state, and of identifying a game piece, respectively, according to embodiments. The methods 86, 120 may generally be implemented in one or more modules as a set of logic instructions stored in a machine- or computer-readable storage medium such as random access memory (RAM), read only memory (ROM), programmable ROM (PROM), firmware (FW), flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof.

For example, computer program code to carry out operations shown in methods 86, 120 may be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 88 divides an image of the board into segments (e.g., squares if the board is a chessboard). Illustrated processing block 90 identifies segments that have game pieces on them and identifies the game pieces. As shown at FIG. 6, illustrated processing block 124 compares a game piece determined to be located at a particular segment of the board to a CNN trained for game pieces. If processing block 126 determines that a sufficiently high confidence match with a game piece has been found, then illustrated processing block 130 associates the matching game piece with the segment, and the process is complete at block 132 for that particular segment.

If block 126 determines that a sufficiently high confidence match with a game piece has not been found, block 128 determines whether all game pieces have been tested. If not, then a comparison with another game piece is made at block 124. If so, then processing block 134 determines whether there is at least a low confidence match to some game piece. In one example, confidence levels may be set by any user (e.g., a player, a game developer, etc.) based on any criteria (e.g., percent similarity, percent match, etc.). If no match is made, then the segment is identified as empty at processing block 138. If block 134 makes at least a low confidence match to a game piece, but the match is not at a sufficiently high confidence level, then there may be a problem with the camera (e.g., position, angle, etc.). Thus, processing block 136 may prompt a player to change the camera position and/or angle to reimage the game board and pieces, and to retry the process at block 124.

Returning to FIG. 5, processing block 92 determines whether all segments of the image have been considered. If not, illustrated processing black 93 considers the next segment of the board, and then control passes back to processing block 90 to identify any game piece at that next segment. If block 92 determines that all segments have been considered, then illustrated processing block 94 takes the data that indicates which game piece is at which segment and forms a listing of those associations. Block 94 also determines a game state from the list. In this regard, the game state may be determined without generating a list, and the game state may be determined in conjunction with an analysis of a game-specific rule set.

Processing block 96 may determine if the game state is valid. A determination of an invalid game state may occur due to problems in capturing images of the game. If block 96 determines that a game state is not valid, the user is notified at illustrated processing block 110 and is prompted to change the camera position and/or angle at illustrated processing block 112. In some embodiments block 96 may also determine that an illegal move has been made (e.g., moving a rook diagonally), resulting in an invalid game state, in which case block 110 so notifies the user to change his move at block 112. A new image is taken and the process is repeated. In addition, a game hint or other information useful to a player concerning strategy and/or a game rule may be generated, for example after block 96 has determined that the game state is valid. In the illustrated example, guidance is generated by processing block 98 and is communicated to a player by illustrated processing block 100.

Accordingly, embodiments disclosed herein permit a player to play a board or other game in physical space using conventional game elements—boards, game pieces, cards, etc.—that generally are substantially less costly than dedicated, electronic versions. Embodiments may be used with board games, card games, and indeed, any game that is played in physical space by players. In addition to having the satisfaction of playing a tabletop or other physical game, the user also has the option to add to his experience by accessing rule sets to resolve disputes, dictionaries (of use with certain language-specific board games), machine intelligence, hints, etc. The game player may play against a local player who may or may not have access to embodiments, or the player may use embodiments to play against remote players via a network. The plugins according to embodiments may be updated regularly, and may be added without requiring the player to acquire new hardware. Thus, embodiments provide for desirable features of both electronic gaming and “old-school” game play using physical, tabletop types of games.

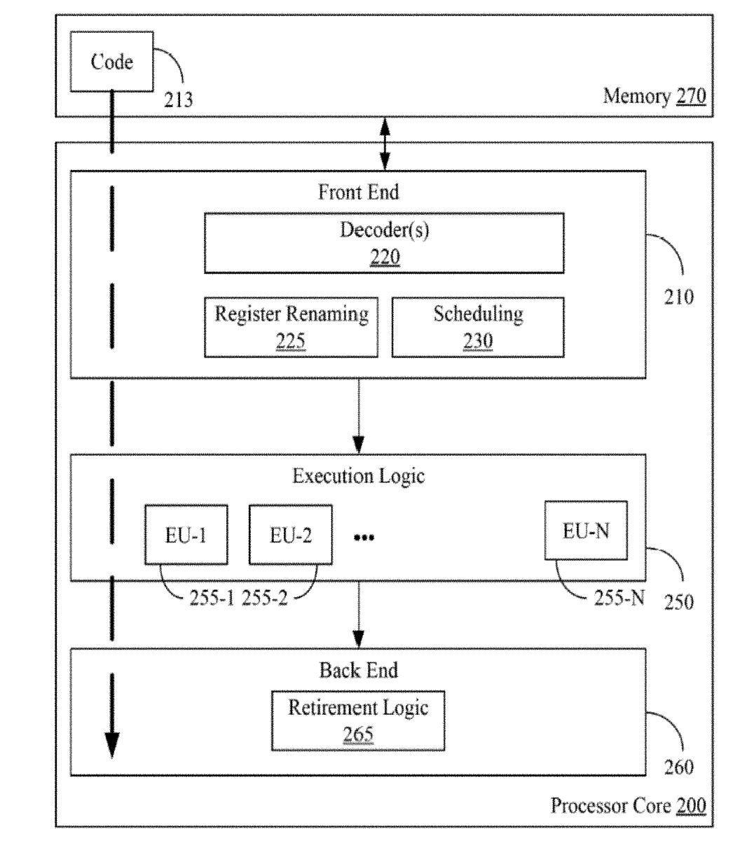

FIG. 7 illustrates a processor core 200 according to one embodiment. The processor core 200 may be the core for any type of processor, such as a micro-processor, an embedded processor, a digital signal processor (DSP), a network processor, or other device to execute code. Although only one processor core 200 is illustrated in FIG. 7, a processing element may alternatively include more than one of the processor core 200 illustrated in FIG. 7. The processor core 200 may be a single-threaded core or, for at least one embodiment, the processor core 200 may be multithreaded in that it may include more than one hardware thread context (or “logical processor”) per core.

FIG. 7 also illustrates a memory 270 coupled to the processor core 200. The memory 270 may be any of a wide variety of memories (including various layers of memory hierarchy) as are known or otherwise available to those of skill in the art. The memory 270 may include one or more code 213 instruction(s) to be executed by the processor core 200, wherein the code 213 may implement the system 22 (FIGS. 1A-1B), the system 30 (FIG. 2), the plugin 50 (FIG. 3), the method 70 (FIG. 4), the method 86 (FIG. 5), and/or the method 120 (FIG. 6), already discussed. The processor core 200 follows a program sequence of instructions indicated by the code 213. Each instruction may enter a front end portion 210 and be processed by one or more decoders 220. The decoder 220 may generate as its output a micro operation such as a fixed width micro operation in a predefined format, or may generate other instructions, microinstructions, or control signals which reflect the original code instruction. The illustrated front end portion 210 also includes register renaming logic 225 and scheduling logic 230, which generally allocate resources and queue the operation corresponding to the convert instruction for execution.

The processor core 200 is shown including execution logic 250 having a set of execution units 255-1 through 255-N. Some embodiments may include a number of execution units dedicated to specific functions or sets of functions. Other embodiments may include only one execution unit or one execution unit that can perform a particular function. The illustrated execution logic 250 performs the operations specified by code instructions.

After completion of execution of the operations specified by the code instructions, back end logic 260 retires the instructions of the code 213. In one embodiment, the processor core 200 allows out of order execution but requires in order retirement of instructions. Retirement logic 265 may take a variety of forms as known to those of skill in the art (e.g., re-order buffers or the like). In this manner, the processor core 200 is transformed during execution of the code 213, at least in terms of the output generated by the decoder, the hardware registers and tables utilized by the register renaming logic 225, and any registers (not shown) modified by the execution logic 250.

Although not illustrated in FIG. 7, a processing element may include other elements on chip with the processor core 200. For example, a processing element may include memory control logic along with the processor core 200. The processing element may include I/O control logic and/or may include I/O control logic integrated with memory control logic. The processing element may also include one or more caches.

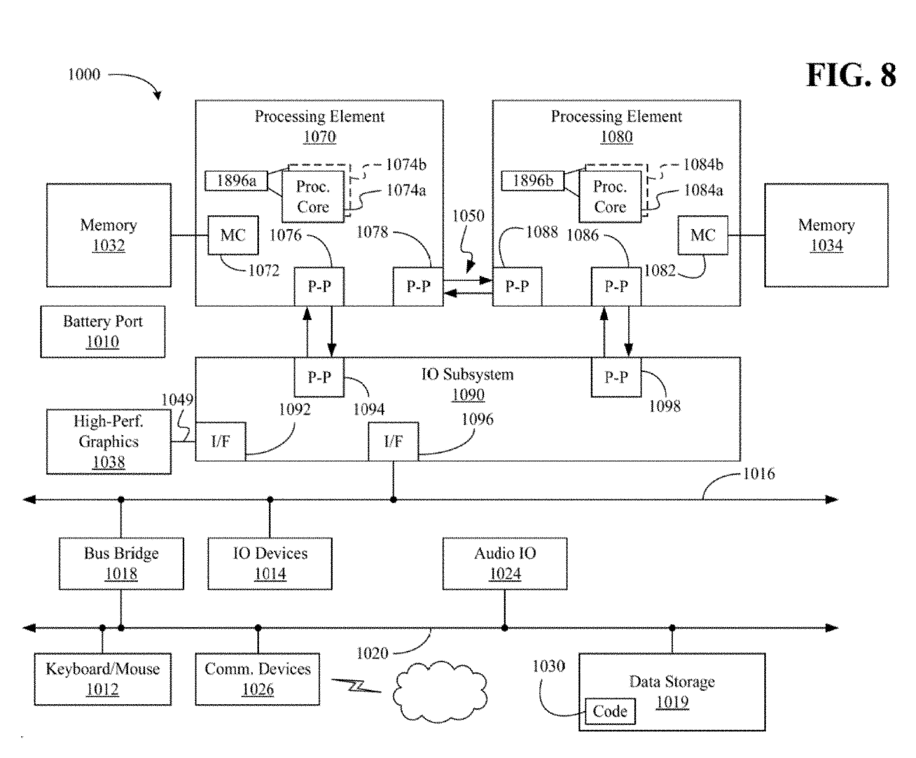

Referring now to FIG. 8, shown is a block diagram of a computing system 1000 embodiment in accordance with an embodiment. Shown in FIG. 8 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 8 may be implemented as a multi-drop bus rather than point-to-point interconnect.

As shown in FIG. 8, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 7.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 8, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 8, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 8, various I/O devices 1014 (e.g., biometric scanners, speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement the system 22 (FIGS. 1A-1B), the system 30 (FIG. 2), the plugin 50 (FIG. 3), the method 70 (FIG. 4), the method 86 (FIG. 5), and/or the method 120 (FIG. 6), already discussed, and may be similar to the code 213 (FIG. 7), already discussed. Further, an audio I/O 1024 may be coupled to second bus 1020 and a battery port 1010 may supply power to the computing system 1000.

Note that other embodiments are contemplated. For example, instead of the point-to-point architecture of FIG. 8, a system may implement a multi-drop bus or another such communication topology. Also, the elements of FIG. 8 may alternatively be partitioned using more or fewer integrated chips than shown in FIG. 8.

### Additional Notes and Examples

Example 1 may include a system comprising a camera to capture an image of a game that is to be played in a field of view of the camera, a segmenter, implemented at least partly in one or more of configurable logic or fixed functionality logic hardware, to divide the image into one or more segments and identify a game piece for each of the one or more segments if the game piece is present at the segment, and a state analyzer implemented at least partly in one or more of configurable logic or fixed functionality logic hardware and communicatively coupled to the segmenter, the state analyzer to define a game state based on the game piece at the segments identified by the segmenter.

Example 2 may include the system of Example 1, further including glasses that include the camera.

Example 3 may include the system of any one of Examples 1 to 2, wherein the segmenter is to include a convolutional neural network (CNN) that is to identify the game.

Example 4 may include the system of any one of Examples 1 to 3, wherein the CNN is to identify the one or more segments and the game piece of the game.

Example 5 may include the system of any one of Examples 1 to 4, further including a rules database, wherein the segmenter is to identify a game corresponding to the image, and wherein the state analyzer is to retrieve a set of rules from the rules database and apply the set of rules to the game to define the game state.

Example 6 may include the system of any one of Examples 1 to 5, further including a game controller communicatively coupled to the camera to pre-process data provided by the camera into a form that is suitable for use by a CNN and engage at least one of a plurality of game-specific plugins, each of the game-specific plugins to include a respective segmenter and a respective state analyzer, wherein the rules database is to be distributed among the game-specific plugins.

Example 7 may include the system of any one of Examples 1 to 6, further including a communications channel to convey information relating to one or more of a game state, a rule, or a suggestion to a player of the game.

Example 8 may include a method comprising automatically dividing an image of a game played in a field of view of a camera to divide the image into one or more segments, automatically identifying a game piece for each of the one or more segments if the game piece is present at the segment, and automatically defining a game state based on the game pieces identified at the segments.

Example 9 may include the method of Example 8, wherein the camera is located on glasses.

Example 10 may include the method of any one of Examples 8 to 9, further including using a convolutional neural network (CNN) to identify the game.

Example 11 may include the method of any one of Examples 8 to 10, wherein the CNN identifies the segments and game pieces of the game.

Example 12 may include the method of any one of Examples 8 to 11, further including identifying a game corresponding to the image, and retrieving a set of rules from a rules database and applying the set of rules to the game to define the game state.

Example 13 may include at least one computer readable storage medium comprising a set of instructions which, when executed by a computing device, cause the computing device to automatically divide an image of a game played in a field of view of a camera to divide the image into one or more segments, automatically identify a game piece for each of the one or more segments if the game piece is present at the segment, and automatically defining a game state based on the game pieces identified at the segments.

Example 14 may include the at least one computer readable storage medium of Example 13, wherein the camera is located on glasses.

Example 15 may include the at least one computer readable storage medium of any one of Examples 13 to 14, wherein the instructions cause a convolutional neural network (CNN) to identify the game.

Example 16 may include the at least one computer readable storage medium of any one of Examples 13 to 15, wherein the CNN identifies the segments and game pieces of the game.

Example 17 may include the at least one computer readable storage medium of any one of Examples 13 to 16, wherein the instructions, when executed, cause the computing device to identify a game corresponding to the image, and retrieve a set of rules from a rules database and apply the set of rules to the game to define the game state.

Example 18 may include the at least one computer readable storage medium of any one of Examples 13 to 17, wherein the instructions, when executed, cause the computing device to pre-process data from the camera into a form that is suitable for use by a CNN, and engage at least one of a plurality of game-specific plugins, each of which divides the image and identifies the game piece, wherein the rules database is distributed among the game-specific plugins.

Example 19 may include the at least one computer readable storage medium of any one of Examples 13 to 18, wherein the instructions, when executed, cause the computing device to convey information relating to one or more of a game state, a rule, or a suggestion to a player of the game.

Example 20 may include an apparatus comprising a segmenter, implemented at least partly in one or more of configurable logic or fixed functionality logic hardware, to divide an image of a game that is to be played in a field of view of a camera into one or more segments, and identify a game piece for each of the one or more segments if the game piece is present at the segment, and a state analyzer implemented at least partly in one or more of configurable logic or fixed functionality logic hardware and communicatively coupled to the segmenter, the state analyzer to define a game state based on the game pieces at the segments identified by the segmenter.

Example 21 may include the apparatus of Example 20, further including a display to display data relating to a game state, a rule, or a suggestion relating to the game.

Example 22 may include the apparatus of any one of Examples 20 to 21, wherein the segmenter is to include a convolutional neural network (CNN) that is to identify the game.

Example 23 may include the apparatus of any one of Examples 20 to 22, wherein the CNN is to identify the one or more segments and the game pieces of the game.

Example 24 may include the apparatus of any one of Examples 20 to 23, further including a rules database, wherein the segmenter is to identify a game corresponding to the image, and wherein the state analyzer is to retrieve a set of rules from the rules database and apply the set of rules to the game to define the game state.

Example 25 may include the apparatus of any one of Examples 20 to 24, further including a game controller communicatively coupled to the camera to pre-process data provided by the camera into a form that is suitable for use by a CNN, and engage at least one of a plurality of game-specific plugins, each of the game-specific plugins to include a respective segmenter and a respective state analyzer, wherein the rules database is to be distributed among the game-specific plugins.

Example 26 may include a computer vision system for use with tabletop gaming, comprising a camera to capture an image of a game, a game controller communicatively coupled to the camera to process the image for further image analysis, a segmenter communicatively coupled to the game controller, the segmenter to divide the image into a plurality of segments, and for each segment, to determine if a game piece is present at the segment and identify the game piece if the game piece is present, and a state analyzer communicatively coupled to the segmenter, the state analyzer to define a game state based on the segments and any game pieces identified at the game segments.

Example 27 may include the system of Example 26, wherein the camera is a wearable camera.

Example 28 may include the system of any one of Examples 26 to 27, wherein the camera is a depth camera.

Example 29 may include the system of any one of Examples 26 to 28, wherein the segmenter includes a convolutional neural network (CNN) to identify the game.

Example 30 may include the system of any one of Examples 26 to 29, wherein the CNN of the segmenter is to identify the segments and game pieces of the game.

Example 31 may include the system of any one of Examples 26 to 30, wherein the segmenter is to identify a game corresponding to the image.

Example 32 may include the system of any one of Examples 26 to 31, further including a rules database, wherein the state analyzer is to retrieve a set of rules relating to the game from the rules database and apply the set of rules to the game to define the game state.

Example 33 may include the system of any one of Examples 26 to 32, wherein the rules database is distributed among one or more game-specific plugins.

Example 34 may include the system of any one of Examples 26 to 33, wherein the game controller is to engage at least one of a plurality of game-specific plugins, each of the game-specific plugins to include a respective segmenter and a respective state analyzer.

Example 35 may include the system of any one of Examples 26 to 34, further including a knowledge database to provide one or more game hints to a player.

Example 36 may include the system of any one of Examples 26 to 35, further including a display to present the game hints to the player.

Example 37 may include the system of any one of Examples 26 to 36, further including a plurality of cameras corresponding to a plurality of players.

Example 38 may include the system of any one of Examples 26 to 37, wherein the game controller is to pre-process image data including processing the image data into a form optimized for a CNN.

Example 39 may include the system of any one of Examples 26 to 38, wherein the pre-processing of image data includes adjusting an optical-to-electrical transfer function for a higher dynamic range.

Example 40 may include a method comprising digitizing an image of a game, dividing the image into one or more segments, determining if a game piece is present for each of the one more segments, and identifying the game piece if the game piece is present, making an association between specific game pieces and specific segments and recording the associations in a list, and identifying a game state based on the list.

Example 41 may include the method of Example 40, wherein the image of the game is provided by a wearable depth camera.

Example 42 may include the method of any one of Examples 40 to 41, further including using a convolutional neural network (CNN) to identify the game, segments, and game pieces.

Example 43 may include the method of any one of Examples 40 to 42, wherein the CNN identifies a game corresponding to the image, further including retrieving a set of rules from a rules database and applying the set of rules to the game to define the game state.

Example 44 may include the method of any one of Examples 40 to 43, wherein the rules database is distributed among one or more game-specific plug-ins.

Example 45 may include the method of any one of Examples 40 to 44, further including conveying information relating to one or more of a game state, a rule, or a suggestion to a player of the game.

Example 46 may include the method of any one of Examples 40 to 45, further including recording the game state in a notation and providing the notation to a remote location.

Example 47 may include an apparatus comprising means for automatically digitizing an image of a game, means for dividing the image into segments and for each segment means for identifying a game piece if one is present at the segment, and means for defining a game state based on the game pieces and segments.

Example 48 may the apparatus of Example 47, further including a display to display data relating to a game state, a rule, or a suggestion relating to the game.

Example 49 may include the apparatus of any one of Examples 47 to 48, further including means for identifying the game.

Example 50 may include the apparatus of any one of Examples 47 to 49, further including means for recording the game state in a standard notation and providing the game state in that notation to a remote location.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A system comprising:
a camera to capture an image of a game that is to be played in a field of view of the camera;
a segmenter, implemented at least partly in one or more of configurable logic or fixed functionality logic hardware, to:
divide the image into one or more segments; and
identify a game piece for each of the one or more segments if the game piece is present at the segment; and
a state analyzer implemented at least partly in one or more of configurable logic or fixed functionality logic hardware and communicatively coupled to the segmenter, the state analyzer to define a game state based on the game piece at the segments identified by the segmenter.

2. The system of claim 1, further including glasses that include the camera.

3. The system of claim 1, wherein the segmenter is to include a convolutional neural network (CNN) that is to identify the game.

4. The system of claim 3, wherein the CNN is to identify the one or more segments and the game piece of the game.

5. The system of claim 1, further including a rules database, wherein the segmenter is to identify a game corresponding to the image, and wherein the state analyzer is to retrieve a set of rules from the rules database and apply the set of rules to the game to define the game state.

6. The system of claim 5, further including a game controller communicatively coupled to the camera to:
pre-process data provided by the camera into a form that is suitable for use by a CNN; and
engage at least one of a plurality of game-specific plugins, each of the game-specific plugins to include a respective segmenter and a respective state analyzer, wherein the rules database is to be distributed among the game-specific plugins.

7. The system of claim 1, further including a communications channel to convey information relating to one or more of a game state, a rule, or a suggestion to a player of the game.

8. A method comprising:
automatically dividing an image of a game played in a field of view of a camera into one or more segments;
automatically identifying a game piece for each of the one or more segments if the game piece is present at the segment; and
automatically defining a game state based on the game piece identified at the segments.

9. The method of claim 8, wherein the camera is located on glasses.

10. The method of claim 8, further including using a convolutional neural network (CNN) to identify the game.

11. The method of claim 10, wherein the CNN identifies the segments and game pieces of the game.

12. The method of claim 8, further including:
identifying a game corresponding to the image; and
retrieving a set of rules from a rules database and applying the set of rules to the game to define the game state.

13. At least one computer readable storage medium comprising a set of instructions which, when executed by a computing device, cause the computing device to:
automatically divide an image of a game played in a field of view of a camera into one or more segments;
automatically identify a game piece for each of the one or more segments if the game piece is present at the segment; and
automatically define a game state based on the game pieces identified at the segments.

14. The at least one computer readable storage medium of claim 13, wherein the camera is located on glasses

15. The at least one computer readable storage medium of claim 13, wherein the instructions cause a convolutional neural network (CNN) to identify the game.

16. The at least one computer readable storage medium of claim 15, wherein the CNN identifies the segments and game pieces of the game.

17. The at least one computer readable storage medium of claim 13, wherein the instructions cause the computing device to:
identify a game corresponding to the image; and
retrieve a set of rules from a rules database and apply the set of rules to the game to define the game state.

18. The at least one computer readable storage medium of claim 17, wherein the instructions cause the computing device to:
pre-process data from the camera into a form that is suitable for use by a CNN; and
engage at least one of a plurality of game-specific plugins, each of which divides the image and identifies the game piece, wherein the rules database is distributed among the game-specific plugins.

19. The at least one computer readable storage medium of claim 13, wherein the instructions cause the computing device to convey information relating to one or more of a game state, a rule, or a suggestion to a player of the game.

20. An apparatus comprising:
a segmenter, implemented at least partly in one or more of configurable logic or fixed functionality logic hardware, to:
divide an image of a game that is to be played in a field of view of a camera into one or more segments; and
identify a game piece for each of the one or more segments if the game piece is present at the segment; and
a state analyzer implemented at least partly in one or more of configurable logic or fixed functionality logic hardware and communicatively coupled to the segmenter, the state analyzer to define a game state based on the game piece at the segment identified by the segmenter.

21. The apparatus of claim 20, further including a display to display data relating to a game state, a rule, or a suggestion relating to the game.

22. The apparatus of claim 20, wherein the segmenter is to include a convolutional neural network (CNN) that is to identify the game.

23. The apparatus of claim 22, wherein the CNN is to identify the one or more segments and the game piece of the game.

24. The apparatus of claim 20, further including a rules database, wherein the segmenter is to identify a game corresponding to the image, and wherein the state analyzer is to retrieve a set of rules from the rules database and apply the set of rules to the game to define the game state.

25. The apparatus of claim 24, further including a game controller communicatively coupled to the camera to:
pre-process data provided by camera into a form that is suitable for use by a CNN; and
engage at least one of a plurality of game-specific plugins, each of the game-specific plugins to include a respective segmenter and a respective state analyzer, wherein the rules database is to be distributed among the game-specific plugins.
